(19) United States
(12) Patent Application Publication
(10) Pub. No.: US 2007/0013099 A1
(43) Pub. Date: Jan. 18, 2007

(54) Method And Apparatus For Emobssing Manufactured Deck Boards

(75) Inventors: David Craig Humphreys, Joplin, MO (US); Justin Leo Braker, Lamar, MO (US); Jason Wayne Randolph, Nixa, MO (US)

Correspondence Address: BLACKWELL SANDERS PEPER MARTIN LLP, 4801 Main Street, Suite 1000, KANSAS CITY, MO, 64112, US

(73) Assignee: EPOCH COMPOSITE PRODUCTS, INC., Joplin, MO (US)

(21) Appl. No.: 11/160,946

(22) Filed: Jul. 15, 2005

(51) Int. Cl. B29C 47/00; B29C 59/02

(52) U.S. Cl. 264/151; 425/385; 264/210.2; 264/211

(57) ABSTRACT

A method and apparatus are provided for forming embossed simulated boards through a combination of extrusion molding process and separate embossing step. During embossing, the extrudate from the extruder is pressure formed forming a texturized surface on at least one face of the board with the board being captured on all sides of the board during the embossing step. After embossing, the extrudate is cooled to a temperature sufficient to rigidify the thus cooled extrudate. The cooled extrudate may then be cut into the appropriate lengths.

### BACKGROUND OF INVENTION

Composite boards and/or lumber is often made by a molding process and may be used to replace 100% wood in outdoor decks and other outdoor items and may include substitutes for decking, posts, rails, fencing, pickets, slats, shingles, siding and the like and particularly those items or structural elements with a generally uniform cross sectional shape along their length (herein board or board like member). Manufacturing processes can include extrusion or compression molding. During compression molding, a surface finish may be applied to simulate wood grain or other decorative patterns. Such a pattern can be embossed in the molded part in the mold typically on one or more of the faces of the finished product. In compression molding, finish can be simultaneously applied to a plurality of the faces including the front main face, the back main face and even the side edges if desired. Forming embossing mold surfaces in a compression mold can be expensive as can molding such parts by compression molding. Compression molding can be slow and can require close control of molding parameters such as charge weight.

However, when extruding, the extrusion die opening needs to be smooth in order for the extrudate to pass effectively through the die opening resulting in surfaces that are generally smooth. Longitudinally extending impressions may be provided, but they do not simulate a wood texture as would be desirable for simulated wood. Generally, transversely extending impressions cannot be formed in the extrusion die head. An extrusion molding process provides advantages over a compression molding process in its speed of operation, cost of tooling, elimination of the requirement to pre-weighed charges for the compression mold, increased robustness, flexibility, functionality at various stages, production rates, and the benefit of continuous production.

Another advantage of extrusion is that any length of product can be easily made by simply timing the cutting apparatus differently to make the appropriate cross cuts. However, the appropriate formation of a random grain pattern cannot be easily accomplished in the extruder die head during the extrusion process if at all.

The manufacturing of board like members provides advantages over natural wood in that the manufactured product has longer life, dimensional stability, rot resistance, splitting and cracking resistance and can be provided with a permanent finish that does not need staining and/or painting during its life. Additionally, such manufactured product can be made from recycled materials and can have its cost of production reduced by using waste materials such as sawdust and the like as a bulk filler. Other natural materials such as rice hulls and flax may be added. A manufactured product can also be provided generally with any properties desired; for example, strength, stiffness, hardness, flexure, shape or contour and the like and results in little if any waste. Additionally, wood products are becoming more expensive and good quality wood is difficult to find that has the grain running in the correct direction and is knot free or has a few knots and other inherent imperfections. Additionally, wood products can present problems to a user; for example, splinters and the like and must be maintained.

The present invention provides a method of manufacturing board like members (simulated lumber, simulated wood products or the like) and an apparatus for manufacturing the same which is simple and economical to use and overcomes the above problems.

### SUMMARY OF INVENTION

The present invention involves the provision of an apparatus for forming a textured surface on at least one face of an extruded board like member wherein the apparatus includes a pair of oppositely rotating forming drums, forming an opening substantially closed on all lateral sides. The surfaces contacting the extrudate each have a surface speed that are substantially identical. The speed of the drums may be varied, through a drive control means to match the speed of the extrudate exiting the extruder. The forming apparatus can further include a cooling device such as a water tank, for cooling the thus surface embossed or texturized extrudate.

The present invention also involves the provision of a method of forming a manufactured board like member. The manufacturing process includes forming an extrudate generally with a cross sectional shape of a desired board like member, and prior to becoming rigid through cooling, the extrudate is passed between a pair of forming drums while at a temperature suitable for embossing that form a texturized or embossed surface of suitable form on the formed board member after which the member is cooled to the point where it is self-supporting and no longer easily heat formable at the cooled temperature. The drums are appropriately positioned relative to one another to provide the desired amount of pressure on the surfaces to effect the heat/pressure forming. The drums are preferably cooled to help the member surface take a set and be no longer heat formable with the cooling being further effected by an appropriate cooling device such as a water tank.

### DETAILED DESCRIPTION OF DRAWINGS

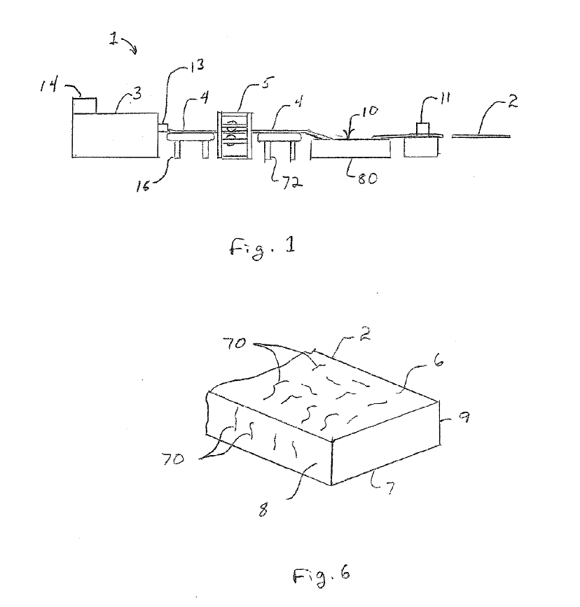

FIG. 1 is a schematic illustration of the forming apparatus including an extruder, embosser or texturizer and downstream cooling device.

FIG. 2 is a perspective view of the embossing apparatus.

FIG. 3 is a side elevation view of the embossing apparatus of FIG. 2.

FIG. 4 is a top plan view of the embosser of FIG. 2; and

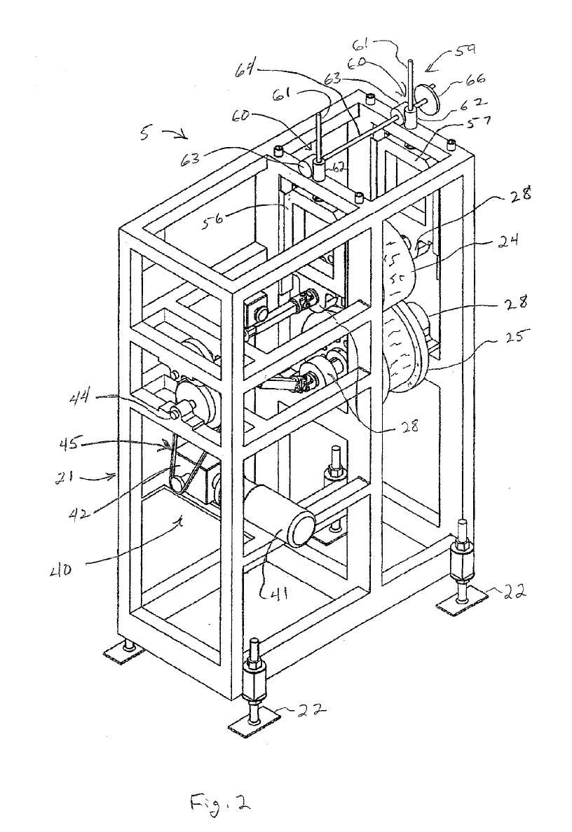

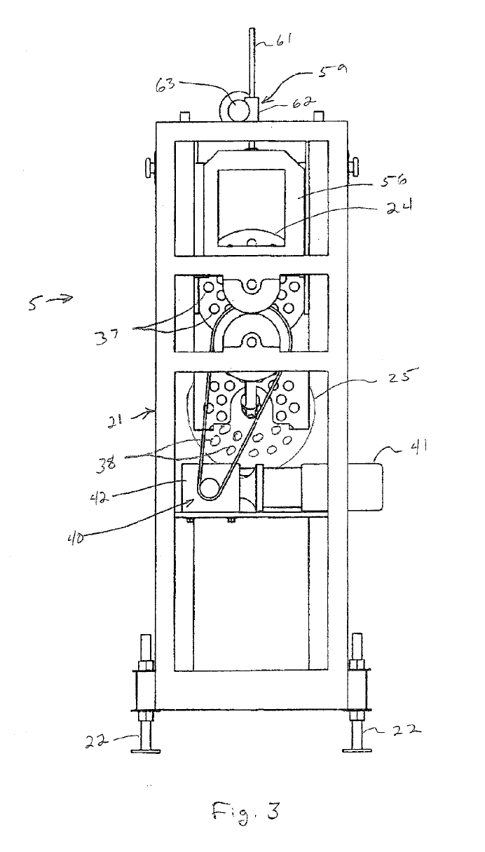

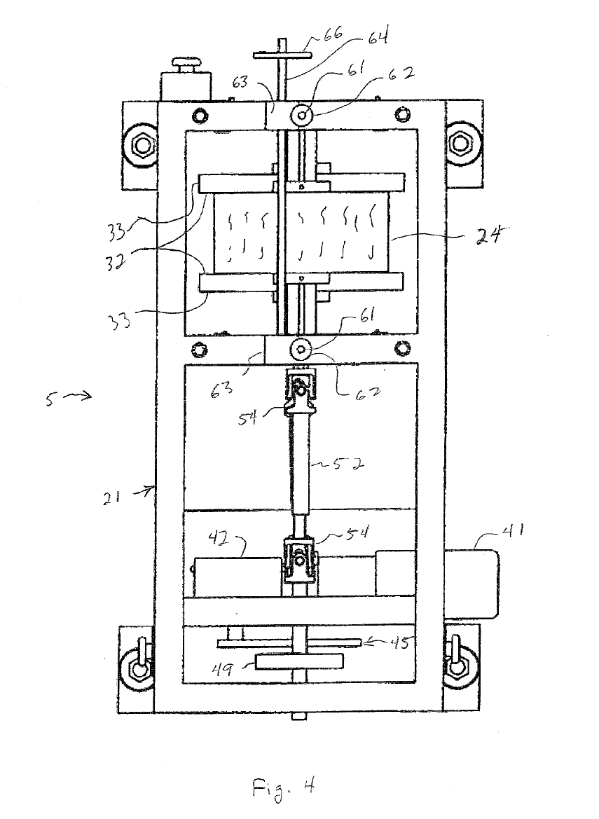

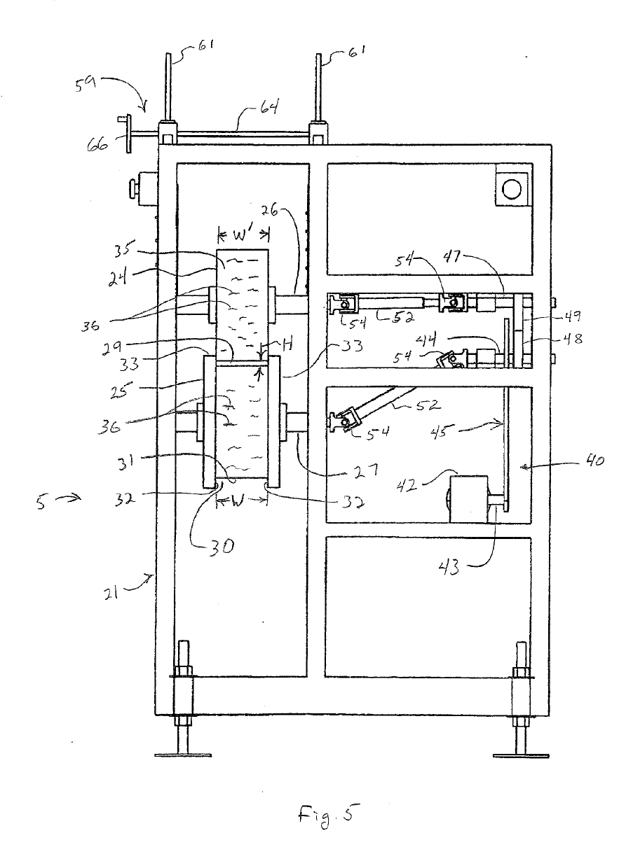

FIG. 5 is a front elevation view of the embosser of FIG. 2.

FIG. 6 is a fragmentary perspective view of a formed board like member.

Like numbers throughout, the various figures indicate like or similar parts.

### DETAILED DESCRIPTION

The reference 1 designates generally a production line for the manufacture of manufactured board like members (herein boards for simplicity) 2. The line 1 as best seen in FIG. 1, includes an extruder 3 that forms an extrudate 4 which is a board 2 precursor. The formed extrudate is fed to an embossing apparatus 5 that embosses or texturizes at least one of the surfaces 6, 7, 8 and 9 of the extrudate 4. After passing through the embossing apparatus 5 at the embossing station, the extrudate 4 then passes to a cooling device 10 such as a water tank or the like at the cooling station. After exiting the cooling device 10, the extrudate passes to cutting device 11 at a cutting station. The cutter 11 will cut the formed and cooled extrudate 4 into the appropriate lengths forming finished boards 2.

The extruder 3 may be any suitable extruder for the extrusion of polymeric materials. Such extruders can be single screw, multiple screw, piston type and can have one or more die heads 13 from which the extruded material exits for downstream processing as extrudate 4. Such extruders are well known in the art. Such extruders typically have a raw material hopper 14 into which the appropriate raw materials are fed. The materials may be mixed prior to entering the hopper 14 or after entering the hopper so long as the mixing of the material to be extruded is acceptable when the material exits the die head 13. The plastic or polymeric material is usually pelleted and includes a polymer or a blend of polymers such as polypropylene, polyester, polyethylene (high or low density) and the like as desired. The polymeric material may also be provided in granular, powder, shredded or other suitable form. Often, a filler material can be provided to enhance properties of the extrudate 4 or to act as a bulk filler to lessen the cost of the formed extrudate 4. It is not uncommon, to utilize cellulosic material such as sawdust or the like as a filler when making boards 2. Other reinforcing materials can be used such a fibrous glass. Additionally, colorants, plasticizers, additives to help resist UV degradation of the extrudate 4 and the like may also be added. Such materials are well known in the art. In the extruder 3, the material to be extruded is heated to a temperature sufficient to allow pressure forming of the material and to allow the material to form a homogeneous or integral whole. The extruder temperature will be determined by the particular polymer or polymer mixture used and the additional ingredients. For example, if cellulose is used as a filler, the temperature of the extruder and the material in the extruder should be kept lower than the degradation temperature of the cellulosic material. In the extruder, the material is mixed, pressurized, heated and forced through the die head 13 which may have any suitable cross sectional shape, and as shown, rectangular. The die head 13 may be cooled to start the cooling of the extrudate 4. The extruder 3 may also be a zone heated extruder to provide different temperatures at different regions of the extruder 3 as is well known in the art. When exiting the die head 13, the extrudate 4 should have sufficient strength and rigidity to be transferred to subsequent processing equipment. The temperature of the extrudate 4 should be sufficiently high to permit mechanical pressure embossing or texturizing of at least one exterior surface portion of the extrudate 4 but low enough to maintain integrity and shape. A suitable conveyor 16 can be used to convey the extrudate 4 from the die head 13 to the embossing apparatus 5.

The extrudate 4 may have a solid cross sectional composition or may be formed with longitudinally extending passages to reduce the amount of material contained within the extrudate 4. However, typically the use of hollow passages can result in differential cooling and a non-uniform surface shape upon cooling. Additionally, the extrudate 4 may be co-extruded to provide a first material on the inside and a second material on the outside to achieve desired properties.

The embossing apparatus 5 includes a frame 21 to which are mounted various forming and drive components. The frame 21 may be of any construction such as welded steel tubing. It is preferably provided with a plurality of adjusting feet 22 which will allow leveling of the embossing apparatus 5 and its vertical adjustment. The embossing apparatus 5 includes a pair of rollers or drums 24, 25 each rotatably mounted through a respective shaft 26, 27 and bearing mounts 28. The shafts 26, 27 have sufficient size to eliminate or reduce flexing to permit proper pressure embossing of the extrudate 4 between portions of the drums 24, 25. An opening 29 is formed between the drums 24, 25 at the nip therebetween and is at least substantially closed and preferably completely closed on all lateral sides thereof. As shown, one of the drums 24, 25 is provided with a circumferential or peripheral groove defined by an inner surface 31 and surfaces 32 of radially extending flanges 33. The width W between the flanges 33 is selected to provide a snug fit with side surfaces 8, 9 of the extrudate 4 for a purpose to be later described. The other of the drums 24, 25 has a width W′ to fit snugly in the groove 30 but not interfere with the surfaces 32. Thus, the outer surface 35, the surface 31 and the surfaces 32 capture the extrudate 4 therebetween during the texturizing or embossing step while preventing excessive deformation of the extrudate 4 during the embossing step. In the illustrated structure, as seen in FIG. 5, the grooved drum 25 is positioned below the non-grooved drum 24. However, it is to be understood that the relative positions of these two drums could be reversed. At least one of the surfaces 31, 32 and 35 is provided with texturization 36 to form the embossed design on at least one exterior surface of the extrudate 4.

In alternate embodiments, one flange 33 may be on drum 24 and one flange 33 may be on drum 25. One or more side rollers, as described below, may be used to replace one or more of the flanges 33. More than one opening 29 may be provided to simultaneously process a plurality of extrudates 4.

The surface finish of the extrudate 4 may simulate wood grain or the like or various geometric patterns as desired. Preferably, both surfaces 31, 35 are texturized so in the event a flaw is present in one surface, the board 2 may be simply inverted to expose the other surface reducing the possibility of a scrap product. The diameters of the portions of the drums 24, 25 forming the surfaces 31, 35 is sufficient so that a repeat pattern is not visuably apparent, if desired. Additionally, larger diameter drums 24, 25 provide an enhanced ability for cooling of the drums 24, 25 either by air flow through a plurality of through apertures or passages 37, 38. Alternately, cooling liquid such as water which can be provided through a rotating union and various manifolds or flow passages as desired. The apertures 37, 38 go through the drums 24, 25 in a direction generally parallel to the axis of rotation of the drums 24, 25.

A suitable drive structure 40 is provided for rotating each of the drums 24, 25 each with a respective axis of rotation which would be the center of the shafts 26, 27 respectively. Any suitable drive structure 40 can be provided. It is preferred that the drive structure 40 include an electric motor 41 and a reducing gear drive 42 operably connected to the motor 41. Preferably, the motor 41 or the reducing gear box 42 is constructed to provide a variable output speed in order to facilitate matching the surface speed of the drums 24, 25 to the surface speed of the extrudate 4 to prevent or reduce slippage therebetween. A variable speed motor has been found to be effective. As shown, the output shaft 43 of the gear box 42 is connected to a drive shaft 44 via a chain and sprocket drive 45. For example, as seen in FIG. 2, the shaft 44 would rotate clockwise. The drive means 40 is coupled to the shaft 47 via intermeshed gears 48, 49 having the same gear diameter or a different gearing ratio if desired if the circumferential or peripheral lengths of the surfaces 31, 33 are not the same. By intermeshing gears 48, 49, the drum 24 will rotate in a different direction, i.e., counterclockwise, from that of the drum 25. As shown, the shafts 44, 47 are coupled to the shafts 27, 26 respectively, via a respective drive shaft 52, 53 respectively, which may be provided with universal joints 54 so that the shafts 47 and 26 and shaft combination 44, 27 need not be in axial alignment. The shafts 52, 53 are preferably length extensible.

To provide for universal use, it is preferred that at least one of the drums 24, 25 be movable in relationship to the other drum, i.e., their axes of rotation movable relative to one another. In the illustrated structure, and as best seen in FIG. 2, the drum 24 and its shaft 26 are mounted on carriages 56, 57 which in turn are movably mounted on the frame 21 preferably for linear movement. A drive mechanism 59 is provided to selectively raise and lower the drum 24. This can be accomplished by the use of a manually operated crank drive which would include a screw shaft 61 connected to each carriage 56, 57 threadably received within a respective right angle worm gear drive 60 whereby rotation of the gear 62 with the threaded shafts 61 being threadably engaged within the gear 62, will effect raising and lowering of the carriages 56, 57 and hence the drum 24. Such an arrangement also selectively fixes the drum 24 in its selected vertical position. The gears 63 are each in meshed engagement with a respective worm gear 63 which are each mounted to a common shaft 64. A suitable drive is provided for rotating the shaft 64 as desired. As shown, a manual crank 66 can be used, however, it is to be noted that a power drive such as a reversible electric motor operably connected to the shaft 64 may also be used.

Preferably, the outer rim of the drum 24 is received within the groove 30 to form an opening 29 bounded on all sides by the surfaces 31, 32 and 35 transversely or laterally capturing the extrudate within the opening 29. The height H of the opening 29 is adjustable to effect the embossing or texturizing of the desired surfaces or surface of the extrudate 4 without excessive transverse deformation of the extrudate 4. It is a simple matter to adjust the height H to effect the appropriate embossing or texturizing to form the impressions 70 in board 2. The impression 70 may be on the order of 0.001 to about 0.5 inches deep. The exterior surfaces of the drums 24, 25 would be the opposite of the impressions 70 to be formed.

In an alternate embodiment, the flanges 33 may be replaced with rollers to enable embossing of the side portions 8, 9 of the extrudate 4 whereby one to four sides of the extrudate may be emobssed. Such rollers may be suitably driven by the drive means 40 to maintain timing between the drums 24, 25 and the rollers. Once the extrudate 4 passes between the drums 24, 25, it can be directed to a take away conveyor 72 or a series of supports for the thus embossed extrudate to transfer to the cooling apparatus 10 of station cooling for cooling. A suitable cooling apparatus 10 can include a water tank 80 having water therein maintained at a suitable temperature to effect cooling of the thus embossed extrudate 4. Complete cooling of the extrudate 4 to room temperature need not occur in the cooling station 10 but can be accomplished by allowing the extrudate to rest in a room for an adequate period of time for the temperature to be reduced the desired degree. The extrudate 4, after cooling is transferred to a cutting device 11 at the cutting station where the extrudate 4 can be cut into the desired lengths as is well known in the art. A saw can be used to effect cutting. The thus cut and cooled extrudate 4 is now in the form of boards or the like and can be packaged, wrapped and/or stacked for subsequent storage and distribution.

The present invention is better understood by a description of the method of making the finished board like member 2. The appropriate materials to extrude are added to the hopper 14 either pre-blended, some pre-blended and some not pre-blended or blending can occur in the hopper 14. The polymeric material such as polyethylene, polypropylene, polyester, nylon or the like, as desired, or blends of polymers, are utilized. Fillers, colorants, UV stabilizers, plasticizers and the like can be included in the material to be extruded. The material is heated, pressurized and forced to flow through the die head 13 thereby forming the desired cross sectional shape. A transverse cross section of the extrudate 4 may be solid, may be provided in a co-extrusion, and/or may be provided with hollow passageways as desired. The extrudate 4 may be cooled from the temperature from inside the extruder barrel prior to exiting the extruder 3 if desired. The temperature of the extrudate 4 is such as to permit its being embossed or texturized by permanent deformation by the drums 24, 25 having an embossing pattern on at least one of the drums 24, 25. The cross sectional shape of the opening 29 formed by the drums 24, 25 and flanges 33 is generally similar to the cross sectional shape and size of the extrudate 4 and the opening 29 are such, and in particular the height H of the opening 29 is such as to provide permanent deformation of at least one surface of the extrudate 4 by at least one embossing surface of the drum 24, 25. The drums 24, 25 may be cooled to help set the surface once it has been embossed and also to prevent heat build-up which may interfere with the embossing process. As noted, the extrudate 4 is captured preferably on all sides thereof during the embossing step. The capturing can be done by the outer surfaces of the drums 24, 25 and by the flanges 33 or in the alternative, rotating wheels or the like. Thus, any pressure applied to the extrudate 4 while in the opening 29, is restrained because of the capturing of the extrudate at least substantially completely on all sides of the extrudate 4 during the embossing process. The temperature of the extrude is reduced in the cooling apparatus 10 to a temperature at which it is sufficiently rigid to be self-supporting and may not be easily permanently deformed through normal pressure application.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An embossing apparatus for embossing an extruded board like member having generally opposite faces, said apparatus including:
a frame structure;
a pair of drums each having a peripheral exterior surface with a space therebetween and facing one another at a nip between the drums, said peripheral exterior surfaces each being positioned to engage a respective opposite face of an extrudate passing therebetween adjacent the nip;
a pair of side members each positioned at a respective opposite side of the nip to form an opening substantially closed on all sides thereof for receipt of an extrudate therebetween;
a drive arrangement operably connected to the drums to effect rotation of the drums in opposition directions with the peripheral exterior surfaces movable by the drive arrangement at approximately the same speed; and
embossing on at least one of the peripheral exterior surfaces.

2. The embossing apparatus as set forth in claim 1 wherein the pair of side members including a pair of flanges each mounted on at least one of the drums and extending radially outwardly therefrom.

3. The embossing apparatus as set forth in claim 2 wherein the pair of flanges each being mounted on the same drum partially defining a circumferential groove therebetween.

4. The embossing apparatus as set forth in claim 1 including an adjuster mechanism operably connected to one said drum and mounted to the frame and operable to selectively adjust a height of the opening.

5. The embossing apparatus as set forth in claim 4 wherein the adjuster mechanism including a pair of carriages, each being movably mounted on the frame, one said drum being mounted to a first shaft having opposite end portions with each carriage having a respective opposite shaft end portion rotatably mounted thereto.

6. The embossing apparatus as set forth in claim 5 wherein the adjuster mechanism including a second drive apparatus operably connected to the carriages to effect selective simultaneous movement thereof in the same direction.

7. The embossing apparatus as set forth in claim 1 wherein the side members each including a roller having a peripheral surface for engaging a respective side face of an extrudate passing thereby.

8. A forming apparatus for forming a board like member with at least one embossed surface portion, said formed board like member having generally opposite side faces and generally opposite edges, set apparatus including:
an extruder having a die head, said extruder and die head being adapted to form an extrudate;
a frame structure;
a pair of drums each having a peripheral exterior surface with a space therebetween and facing one another at a nip between the drums, said peripheral exterior surfaces each being positioned to engage a respective opposite side face of an extrudate from the extruder and passing therebetween adjacent to the nip;
a pair of side members each positioned at a respective opposite side of the nip to form an opening substantially closed on all sides thereof for receipt of an extrudate therebetween;
a drive arrangement operably connected to the drums to effect rotation of the drums in opposite directions with the peripheral exterior surfaces of the drums movable by the drive arrangement at approximately the same speed; and
embossing on at least one of the peripheral exterior surfaces.

9. The forming apparatus of claim 8 including a cooling device positioned on a discharge side of the drums and operable to receive extrudate after having passed between the pair of drums.

10. The forming apparatus of claim 9 including a cutting device positioned adjacent to a discharge end of the cooling device and adapted to receive cooled extrudate for cutting to selected lengths.

11. The forming apparatus of claim 8 wherein the pair of side members including a pair of flanges each mounted on at least one of the drums and extending radially outwardly therefrom.

12. The forming apparatus as set forth in claim 11 wherein the pair of flanges each being mounted on the same drum partially defining a circumferential groove therebetween.

13. A method of forming a board like member, the method including:
forming an extrudate;
passing the formed extrudate between a pair of drums while the extrudate is still warm enough to permanently pressure form embossing on at least one surface of the extrudate;
forming embossing on at least one surface of the extrudate with at least one of the drums and mechanically resisting lateral expansion of the extrudate during embossing; and
cutting the thus embossed extrudate to length.

14. The method of claim 13 including substantially simultaneously embossing at least two side surfaces of the extrudate.

15. The method of claim 13 wherein the extrudate passing through an opening substantially closed on all sides during said embossing.

16. The method of claim 15 wherein the extrudate is formed by extrusion.

17. The method of claim 16 wherein the extrudate includes at least one polymer.

18. The method of claim 17 wherein the extrudate includes at least one filler.

19. The method of claim 16 wherein the extrudate is a coextrusion.

20. The method of claim 13 wherein the embossing includes simulated wood grain.

21. The method of claim 13 wherein the embossing has a depth of between about 0.001 and about 0.5 inches.

22. The method of claim 13 wherein the extrudate has four elongate surfaces each of which is embossed.
